(19) United States
(12) Patent Application Publication
(10) Pub. No.: US 2024/0208041 A1
(43) Pub. Date: Jun. 27, 2024

(54) ROBOT SYSTEM

(71) Applicant: KAWASAKI JUKOGYO KABUSHIKI KAISHA, Kobe-shi, Hyogo (JP)

(72) Inventors: Hiroki KOKUSHI, Kobe-shi (JP); Hideyuki RYU, Kobe-shi (JP)

(73) Assignee: KAWASAKI JUKOGYO KABUSHIKI KAISHA, Kobe-shi, Hyogo (JP)

(21) Appl. No.: 18/556,893

(22) PCT Filed: Apr. 25, 2022
(86) PCT No.: PCT/JP2022/018745

§ 371 Date: Oct. 24, 2023

(30) Foreign Application Priority Data
Apr. 27, 2021 (JP) 2021-075076

(51) Int. Cl. B25J 3/00; B25J 9/16

(52) U.S. Cl. CPC B25J 3/00; B25J 9/1664

(57) ABSTRACT

A robot system includes a master robot, a slave robot, a controller configured or programmed to control movement of the slave robot based on an operation on the master robot, a clutch operator to temporarily release the slave robot from following the master robot, and a position return operator to return a positional relationship of the master robot with respect to the slave robot to a standard state. The controller is configured or programmed to perform a control to move at least one of the master robot or the slave robot such that a position of the master robot matches a position of the slave robot based on an operation on the position return operator.

### TECHNICAL FIELD

The present disclosure relates to a robot system, and more particularly, it relates to a robot system that performs a procedure such as collecting a specimen from a person to be treated.

### BACKGROUND ART

Conventionally, a specimen collection box for collecting a specimen from a person to be treated is known (see Patent Document 1, for example). Patent Document 1 discloses a specimen collection box including a specimen collection main body box and a pair of protective gloves provided on the specimen collection main body box. In this specimen collection box, an operation person who collects a specimen is placed in the specimen collection main body box and collects the specimen from a person to be treated through the pair of protective gloves.

### PRIOR ART

### Patent Document

Patent Document 1: Japanese Utility Model Registration No.

### SUMMARY OF THE INVENTION

### Problem to be Solved by the Invention

However, in the technology described in Patent Document 1, the operation person is placed in the specimen collection main body box and collects the specimen from the person to be treated through the pair of protective gloves, and thus the operation person needs to be positioned close to the person to be treated. Furthermore, the operation person is placed in the specimen collection main body box, and thus it is necessary to take air into the specimen collection main body box. Therefore, the operation person has a high risk of being infected when collecting the specimen from the person to be treated.

The present disclosure is intended to solve the above problem. The present disclosure aims to provide a robot system capable of reducing the risk of infection from a person to be treated to an operation person.

### Means for Solving the Problem

In order to attain the aforementioned object, a robot system according to an aspect includes a master robot, a slave robot remotely controlled by the master robot to perform a procedure on a person to be treated, a mount connected to a tip end of the slave robot, a hand attached to the mount to hold a treatment member operable to perform the procedure on the person to be treated, a controller configured or programmed to control movement of the slave robot based on an operation on the master robot, a clutch operator to temporarily release the slave robot from following the master robot, and a position return operator to return a positional relationship of the master robot with respect to the slave robot to a standard state. The controller is configured or programmed to perform a control to move at least one of the master robot or the slave robot such that a position of the master robot matches a position of the slave robot based on an operation on the position return operator. The term “to perform a procedure on a person to be treated” in the present disclosure indicates a broader concept including not only collecting a specimen from the person to be treated but also performing an examination on the person to be treated, etc.

As described above, the robot system according to this aspect includes the master robot and the slave robot remotely controlled by the master robot to perform the procedure on the person to be treated. Accordingly, an operation person who operates the master robot does not need to be positioned close to the person to be treated, and thus the risk of infection to the operation person can be reduced when the procedure is performed on the person to be treated.

### Effect of the Invention

As described above, the risk of infection from the person to be treated to the operation person can be reduced.

### BRIEF DESCRIPTION OF THE DRAWINGS

FIG. 1 is a diagram schematically showing a robot system according to an embodiment.

FIG. 2 is a diagram showing the control configuration of the robot system according to the embodiment.

FIG. 3 is a diagram for illustrating specimen collection of the robot system according to the embodiment.

FIG. 4 is a diagram for illustrating an image captured by an imager of the robot system according to the embodiment.

FIG. 5 is a diagram showing a movable range of the robot system according to the embodiment.

FIG. 6 is a flowchart for illustrating an imager posture maintenance process of the robot system according to the embodiment.

FIG. 7 is a flowchart for illustrating a relative position adjustment process of the robot system according to the embodiment.

FIG. 8 is a flowchart for illustrating a movement restriction process of the robot system according to the embodiment.

FIG. 9 is a flowchart for illustrating a movement adjustment process based on three-dimensional shape of the robot system according to the embodiment.

FIG. 10 is a diagram schematically showing a robot system according to a modified example of the embodiment.

FIG. 11 is a diagram for illustrating an example of a procedure performed by the robot system according to the modified example of the embodiment.

### MODES FOR CARRYING OUT THE INVENTION

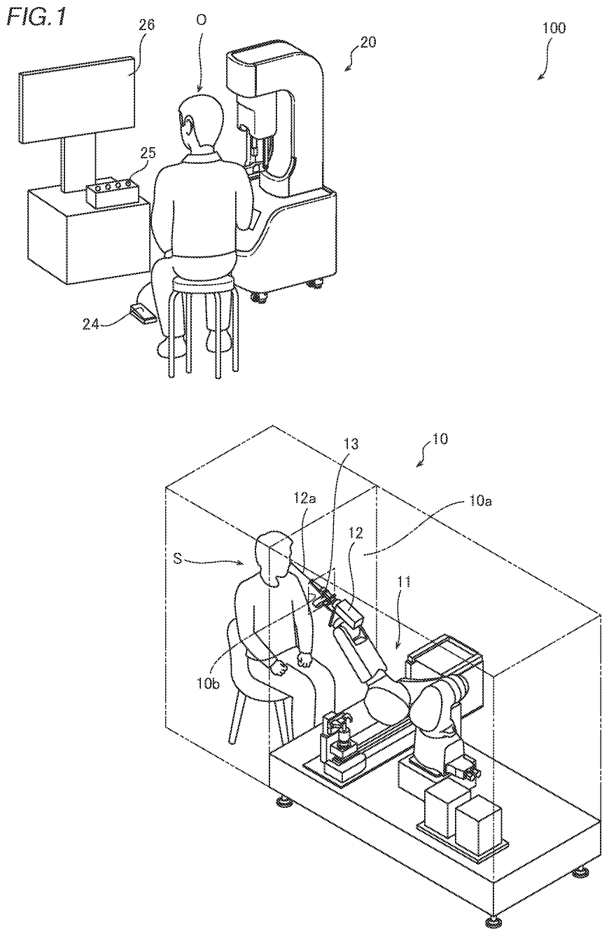

The configuration of a robot system 100 according to an embodiment is now described with reference to FIGS. 1 to 9.

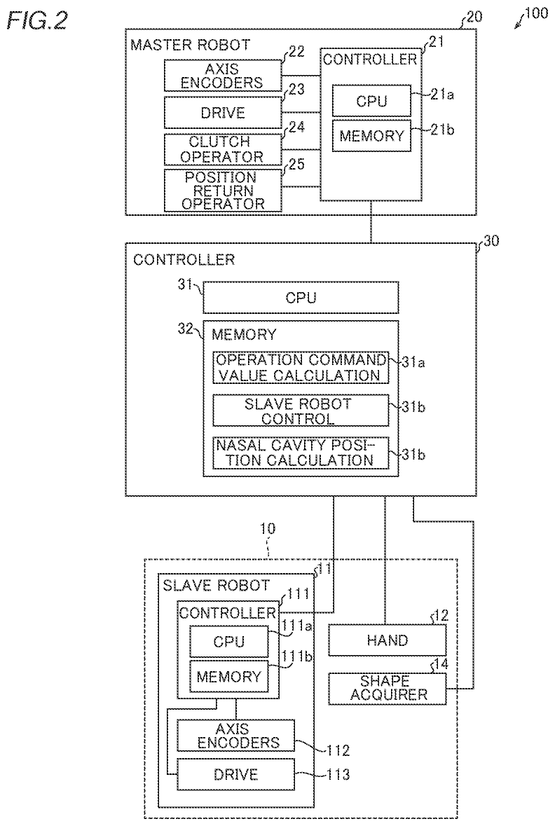

As shown in FIG. 1, the robot system 100 is provided to collect a specimen from a subject S. The robot system 100 includes a booth 10, a slave robot 11, a master robot 20, and a controller 30 (see FIG. 2). The subject S is an example of a “person to be treated” in the claims.

In the booth 10, a specimen is collected from the subject S by the slave robot 11, as shown in FIG. 1. The booth 10 is covered with walls on its sides. The slave robot 11 is arranged in the booth 10. An area of the booth 10 in which the slave robot 11 is arranged is separated from an area into which the subject S enters by a partition wall 10a.

The partition wall 10a is provided between the slave robot 11 and the subject S. The partition wall 10a includes an opening 10b through which a specimen collection member 12a passes. The specimen collection member 12a is an example of a “treatment member” in the claims.

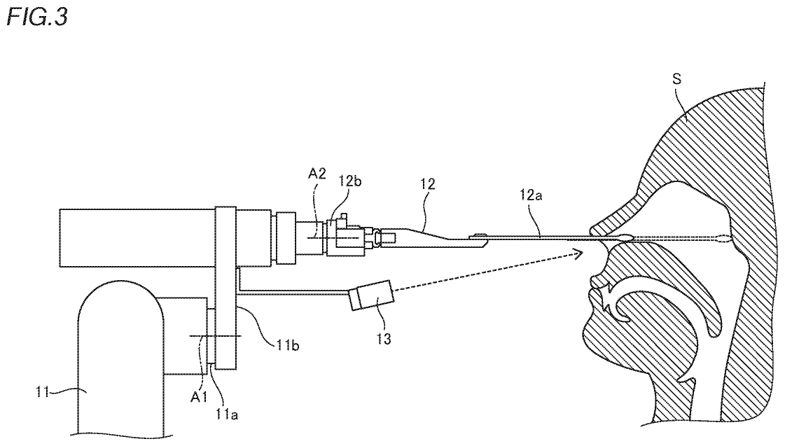

The slave robot 11 is remotely controlled by the master robot 20 to collect a specimen from the subject S. The slave robot 11 collects a specimen from the subject S using the specimen collection member 12a. The specimen collection member 12a is a sterile swab, for example. The sterile swab has a stick shape. The slave robot 11 inserts the specimen collection member 12a into the nasal cavity of the subject S, for example, and collects the specimen (nasopharyngeal swab) from the nasopharynx of the subject S by the inserted specimen collection member 12a, as shown in FIG. 3. The slave robot 11 may insert the specimen collection member 12a into the oral cavity of the subject S to collect the specimen. A virus test such as a PCR (polymerase chain reaction) test is performed on the collected specimen.

The slave robot 11 includes a vertical articulated robot. A hand 12 is provided on a tip end of the slave robot 11. The slave robot 11 has a plurality of (seven, for example) joints. As shown in FIG. 2, each of the plurality of joints of the slave robot 11 includes a drive 113 such as a servomotor, and an encoder 112 that detects the driving position of the drive 113.

As shown in FIG. 3, a mount 11b is connected to the tip end of the slave robot 11. Specifically, the mount 11b is connected to a tip end joint 11a. The tip end joint 11a rotates the mount 11b about a first axis A1.

The hand 12 holds the specimen collection member 12a. The hand 12 includes a pair of gripping members, for example, and grips and holds the specimen collection member 12a with the pair of gripping members.

The slave robot 11 includes a controller 111 that controls movement of the slave robot 11. The controller 111 includes a central processing unit (CPU) 111a and a memory 111b. The CPU 111a controls movement of the slave robot 11 based on a program stored in the memory 111b.

The slave robot 11 is moved in a direction corresponding to a direction in which the operation person O operates a grip at a tip end of the master robot 20. For example, when the operation person O moves the grip of the master robot 20 in an upward-downward direction (Z direction), the hand 12 of the slave robot 11 (and the specimen collection member 12a held by the hand 12) is moved in the upward-downward direction. When the operation person O moves the grip of the master robot 20 in a right-left direction (Y direction), the hand 12 of the slave robot 11 (and the specimen collection member 12a held by the hand 12) is moved in the right-left direction. When the operation person O moves the grip of the master robot 20 in a forward-rearward direction (X direction), the hand 12 of the slave robot 11 (and the specimen collection member 12a held by the hand 12) is moved in the forward-rearward direction. When a specimen is collected from the subject S using the specimen collection member 12a, the operation person O moves the grip of the master robot 20 in a forward direction (X1 direction) to move the hand 12 of the slave robot 11 (and the specimen collection member 12a held by the hand 12) in the forward direction (insertion direction) such that the specimen collection member 12a is inserted into the nasal cavity of the subject S.

As shown in FIG. 3, an imager 13 that images the subject S is attached to the mount 11b. The hand 12 that holds the specimen collection member 12a for collecting a specimen from the subject S is attached to the mount 11b. The hand 12 includes a rotating portion 12b that rotates the specimen collection member 12a about a second axis A2 parallel to the first axis A1. For example, the hand 12 collects a specimen from the subject S by rotating the specimen collection member 12a about the second axis A2 while bringing the specimen collection member 12a into contact with the back of the nasal cavity of the subject S.

The imager 13 is attached to the mount 11b such that the imager 13 is spaced apart downward from the hand 12 and the imaging direction of the imager 13 is inclined upward.

A shape acquirer 14 is provided to acquire the three-dimensional shape of the vicinity of a site of the subject S from which a specimen is to be collected. The shape acquirer 14 includes a three-dimensional scanner or a stereo camera, for example, and acquires three-dimensional data of an object. The shape acquirer 14 is used to acquire the position of the nasal cavity of the subject S. That is, the shape acquirer 14 acquires the three-dimensional shape of the face of the subject S. Furthermore, the shape acquirer 14 acquires the three-dimensional shape of the subject S while the subject S enters the booth 10 and is seated. Moreover, the shape acquirer 14 acquires the three-dimensional shape of the subject S before the specimen is acquired. The shape acquirer 14 may be movably attached to the slave robot 11. Alternatively, the shape acquirer 14 may be fixedly provided within the booth 10.

As shown in FIG. 1, the master robot 20 remotely controls the slave robot 11. Specifically, the master robot 20 remotely controls the slave robot 11 by being operated by the operation person O such as a doctor. The master robot 20 outputs an operation signal based on an operation of the operation person O. The slave robot 11 performs an action corresponding to the operation of the operation person O based on the operation signal from the master robot 20. The slave robot 11 and the master robot 20 are communicably connected to each other by wire or wirelessly.

As shown in FIG. 2, the master robot 20 includes a controller 21, an encoder 22, a drive 23, a clutch operator 24, and a position return operator 25. Furthermore, as shown in FIG. 1, the master robot 20 includes a display 26.

The controller 21 controls movement of the master robot 20 and acquires an operation on the master robot 20 by the operation person O. The controller 21 includes a CPU 21a and a memory 21b. The CPU 21a controls movement of the master robot 20 based on a program stored in the memory 21b.

The encoder 22 detects the driving position of the drive 113 such as a servomotor. The drive 23 drives each joint of the master robot 20.

The clutch operator 24 receives an operation to temporarily release the slave robot 11 from following the master robot 20. That is, when the clutch operator 24 is operated, the slave robot 11 does not move even when the operation person O operates the master robot 20. When the operation on the clutch operator 24 is released, the slave robot 11 moves from a position at which the operation is released to follow an operation on the master robot 20. As shown in FIG. 1, the clutch operator 24 includes a pedal operator that is operated with a foot. The clutch operator 24 may be provided on the grip of the master robot 20.

The position return operator 25 receives an operation to return the positional relationship of the master robot 20 with respect to the slave robot 11 to the standard state. In other words, when the relative positional relationship between the master robot 20 and the slave robot 11 is deviated from the standard state by operating the clutch operator 24, the position return operator 25 is operated such that the relative positional relationship between the master robot 20 and the slave robot 11 is returned to the standard state. As shown in FIG. 1, the position return operator 25 includes a button operated by hand.

The display 26 displays an image (video) of the subject S. The display 26 displays a video captured by the imager 13 (see FIG. 3) provided at the tip end of the slave robot 11 to image the subject S, and a video captured by a camera (not shown) that images the subject S from the side, for example. While checking the real-time video of the subject S displayed on the display 26, the operation person O remotely controls the slave robot 10 using the master robot 20. The display 26 includes a liquid crystal monitor, for example.

The controller 30 includes a CPU 31 and a memory 32, as shown in FIG. 2. The CPU 31 performs a control based on a program stored in the memory 32. The memory 32 stores an operation command value calculation 31a, a slave robot control 31b, and a nasal cavity position calculation 31c as software. The operation command value calculation 31a is connected to the master robot 20, and generates a movement command signal for moving the slave robot 11 based on an operation on the master robot 20. The slave robot control 31b is connected to the slave robot 11, and transmits the movement command signal generated by the operation command value calculation 31a to the slave robot 11. The nasal cavity position calculation 31c is connected to the shape acquirer 14 of the slave robot, and calculates a specimen collection position (nasal cavity) of the subject S.

The controller 30 receives an operation signal for performing a remote control from the master robot 20, and transmits a movement command signal based on the operation signal to the remotely controlled slave robot 11.

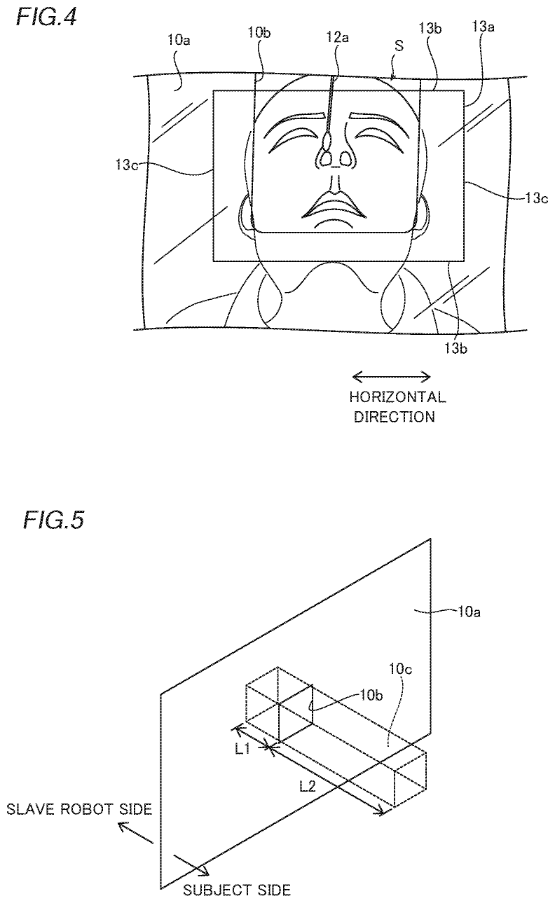

In this embodiment, as shown in FIG. 4, the controller 30 moves the slave robot 11 while adjusting the posture of the imager 13 such that the horizontal side 13b of an image 13a captured by the imager 13 is substantially horizontal when moving the slave robot 11 based on an operation on the master robot 20. In this case, the vertical side 13c of the image 13a captured by the imager 13 is along the upward-downward direction. In other words, as shown in FIG. 3, the positional relationship between the imager 13 and the hand 12 in the upward-downward direction is maintained during specimen collection operation. Furthermore, when moving the slave robot 11 based on an operation on the master robot 20, the controller 30 adjusts the rotation angle of the tip end joint 11a to adjust the posture of the imager 13 such that the horizontal side 13b of the image 13a captured by the imager 13 is substantially horizontal, and adjusts the rotation angle of the rotating portion 12b to adjust rotational movement of the specimen collection member 12a.

Furthermore, when moving the slave robot 11 based on an operation on the master robot 20, the controller 30 moves the slave robot 11 while adjusting the posture of the imager 13 using the vertical articulated robot such that the horizontal side 13b of the image 13a captured by the imager 13 is substantially horizontal.

In this embodiment, the controller 30 performs a control to move at least one of the master robot 20 or the slave robot 11 such that the position of the master robot 20 matches the position of the slave robot 11 based on an operation on the position return operator 25. Specifically, the controller 30 performs a control to move the master robot 20 such that the position of the master robot 20 matches the position of the slave robot 11 while stopping the slave robot 11 based on the operation on the position return operator 25.

In this embodiment, as shown in FIG. 5, the controller 30 moves the slave robot 11 such that the specimen collection member 12a passes through a columnar movable range 10c that is set across the front and back of the opening 10b and follows the shape of the opening 10b. The movable range 10c is set such that a portion of the movable range 10c on the subject S side is longer than a portion of the movable range 10c on the slave robot 11 side with respect to the partition wall 10a. That is, the movable range 10c on the slave robot 11 side has a length L1, and the movable range 10c on the subject S side has a length L2. L1 is smaller than L2. The movable range 10c has a cross-section with the same shape as the opening 10b. Specifically, the movable range 10c has the same rectangular cross-section as the rectangular opening 10b.

In this embodiment, the controller 30 adjusts movement of the slave robot 11 based on the three-dimensional shape acquired by the shape acquirer 14 to move the slave robot 11. Specifically, the controller 30 performs at least one of an adjustment of the initial position of the slave robot 11 for collecting a specimen from the subject S or an adjustment of the movement range of the slave robot 11 for collecting a specimen from the subject S based on the three-dimensional shape acquired by the shape acquirer 14.

### Imager Posture Maintenance Process

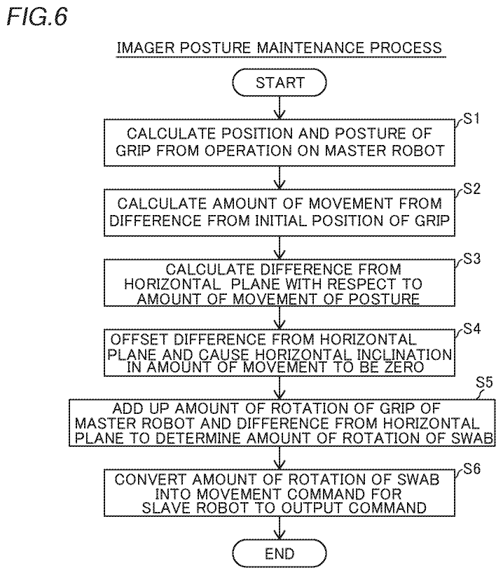

An imager posture maintenance process by the robot system 100 is now described with reference to FIG. 6.

In step S1 of FIG. 6, the controller 21 of the master robot 20 calculates the position and posture of the grip from an operation on the master robot 20 by the operation person O. In step S2, the controller 21 calculates the amount of movement from a difference from the initial position of the grip.

In step S3, the controller 30 calculates a difference of the inclination of the mount 11b (imager 13) from the horizontal plane with respect to the amount of movement of the posture. In step S4, the controller 30 offsets the difference from the horizontal plane, and causes the horizontal inclination of the mount 11b (imager 13) in the amount of movement to be zero. Specifically, the controller 30 adjusts the amount of rotation of the tip end joint 11a.

In step S5, the controller 30 adds up the amount of rotation of the grip of the master robot 20 and the difference from the horizontal plane to determine the amount of rotation of the specimen collection member 12a (swab). In step S6, the controller 30 converts the amount of rotation of the specimen collection member 12a into a movement command for the slave robot 11 to output the command to the slave robot 11. During remote control, the process operations in step S1 to step S6 are repeated to maintain the posture of the imager 13.

### Relative Position Adjustment Process

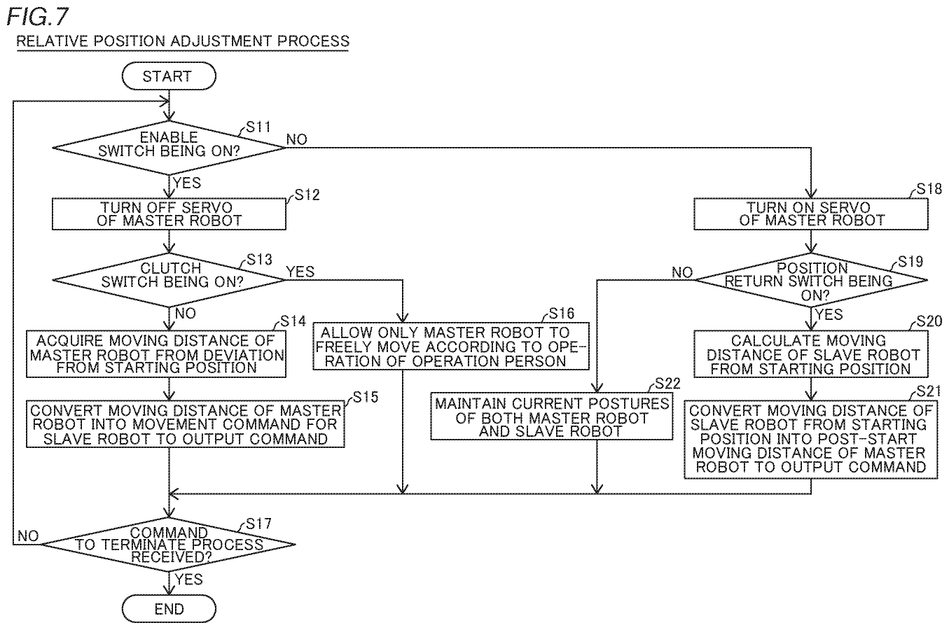

A relative position adjustment process by the robot system 100 is now described with reference to FIG. 7.

In step S11 of FIG. 7, the controller 21 of the master robot 20 determines whether or not an enable switch is on. When the enable switch is on, the process advances to step S12, and when the enable switch is not on (when it is off), the process advances to step S18. In step S12, the controller 21 turns off the servo of the master robot 20.

In step S13, the controller 21 determines whether or not a clutch switch is on. That is, the controller 21 determines whether or not the clutch operator 24 is being operated. When the clutch switch is on, the process advances to step S16, and when the clutch switch is not on (when it is off), the process advances to step S14. In step S14, the controller 21 acquires a moving distance of the master robot 20 from a deviation from the starting position.

In step S15, the controller 21 converts the moving distance of the master robot 20 into a movement command for the slave robot 11 to output the command.

When the clutch operator 24 is operated, in step S16, the controller 21 allows only the master robot 20 to freely move according to an operation of the operation person O. In other words, the operational connection between the master robot 20 and the slave robot 11 is interrupted, and thus the slave robot 11 does not move even when the master robot 20 is moved. Thereafter, when the operation on the clutch operator 24 is released, the process advances to step S17.

In step S17, the controller 21 determines whether or not a command to terminate the process has been received. When the command to terminate the process has been received, the process is terminated. When the command to terminate the process has not been received, the process returns to step S11.

When the enable switch is off, the controller 21 turns on the servo of the master robot 20 in step S18. In step S19, the controller 21 determines whether or not a position return switch is on. That is, the controller 21 determines whether or not the position return operator 25 is being operated. When the position return switch is on, the process advances to step S20, and when the position return switch is not on (when it is off), the process advances to step S22. In step S20, the controller 21 calculates a moving distance of the slave robot 11 from the starting position.

In step S21, the controller 21 converts the moving distance of the slave robot 11 from the starting position into a post-start moving distance of the master robot 20 to output a command. Thus, the master robot 20 is moved, and the positional relationship of the master robot 20 with respect to the slave robot 11 returns to the standard state. After that, the process advances to step S17.

In step S22, both the master robot 20 and the slave robot 11 maintain their current postures. After that, the process advances to step S17.

### Movement Restriction Process

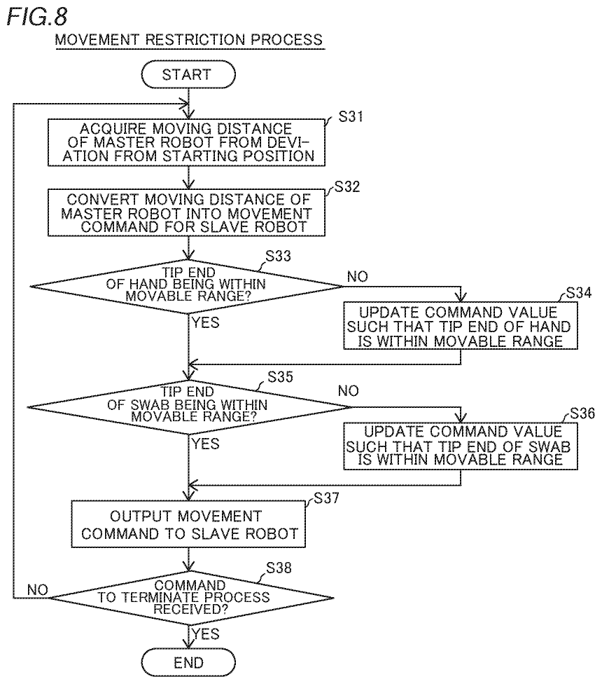

A movement restriction process by the robot system 100 is now described with reference to FIG. 8.

In step S31 of FIG. 8, the controller 21 of the master robot 20 acquires a moving distance of the master robot 20 from a deviation from the starting position. In step S32, the controller 21 converts the moving distance of the master robot 20 into a movement command for the slave robot 11.

In step S33, the controller 30 determines whether or not the movement destination of a tip end of the hand 12 based on the movement command is within the movable range 10c. When it is within the movable range 10c, the process advances to step S35, and when it is not within the movable range 10c (when it is outside the movable range 10c), the process advances to step S34. In step S34, the controller 30 updates the command value such that the tip end of the hand 12 is within the movable range 10c. After that, the process advances to step S35.

In step S35, the controller 30 determines whether or not the movement destination of a tip end of the specimen collection member 12a (swab) based on the movement command is within the movable range 10c. When it is within the movable range 10c, the process advances to step S37, and when it is not within the movable range 10c (when it is outside the movable range 10c), the process advances to step S36. In step S36, the controller 30 updates the command value such that the tip end of the specimen collection member 12a (swab) is within the movable range 10c. After that, the process advances to step S37.

In step S37, the controller 30 outputs the movement command to the slave robot 11. In step S38, the controller 30 determines whether or not a command to terminate the process has been received. When the command to terminate the process has been received, the process is terminated. When the command to terminate the process has not been received, the process returns to step S31.

### Movement Adjustment Process Based on Three-Dimensional Shape

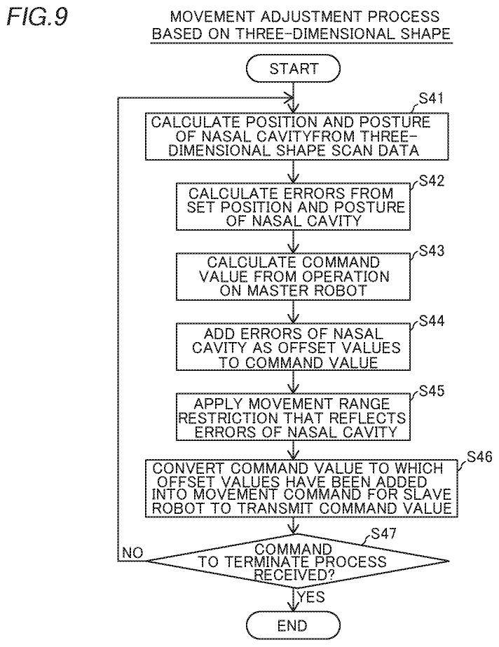

A movement adjustment process based on a three-dimensional shape by the robot system 100 is now described with reference to FIG. 9.

In step S41 of FIG. 9, the controller 30 calculates the position and posture of the nasal cavity from three-dimensional shape scan data of the subject S measured by the shape acquirer 14. In step S42, the controller 30 calculates errors from a preset position and posture of the nasal cavity. The preset position and posture of the nasal cavity are a standard position and posture of the nasal cavity set based on age, gender, race, etc.

In step S43, the controller 30 calculates a command value from an operation on the master robot 20. In step S44, the controller 30 adds the errors of the nasal cavity as offset values to the command value.

In step S45, the controller 30 applies a movement range restriction that reflects the errors of the nasal cavity. In step S46, the controller 30 converts the command value to which the offset values have been added into a movement command for the slave robot 11 to transmit the command value.

In step S47, the controller 30 determines whether or not a command to terminate the process has been received. When the command to terminate the process has been received, the process is terminated. When the command to terminate the process has not been received, the process returns to step S41.

### Advantages of this Embodiment

According to this embodiment, the following advantages are achieved.

According to this embodiment, as described above, the robot system 100 includes the master robot 20 and the slave robot 11 remotely controlled by the master robot 20 to collect a specimen from the subject S. Accordingly, the operation person O who operates the master robot 20 does not need to be positioned close to the subject S, and thus the risk of infection from the subject S to the operation person O can be reduced. Furthermore, when the slave robot 11 is moved to collect a specimen from the subject S, the horizontal inclination of the image 13a captured by the imager 13 attached to the slave robot 11 can be maintained substantially horizontal, and thus the subject S imaged by the imager 13 can be confirmed using the stable captured image 13a. Consequently, a decrease in operability at the time of operating the master robot 20 while viewing the captured image 13a can be reduced or prevented.

According to this embodiment, as described above, the slave robot 11 includes the tip end joint 11a to rotate the mount 11b about the first axis A1. Furthermore, the hand 12 includes the rotating portion 12b to rotate the specimen collection member 12a about the second axis A2 parallel to the first axis A1. Moreover, the controller 30 is configured or programmed to adjust the rotation angle of the tip end joint 11a to adjust the posture of the imager 13 such that the horizontal side 13b of the image 13a captured by the imager 13 is substantially horizontal, and adjust the rotation angle of the rotating portion 12b to adjust rotational movement of the specimen collection member 12a when moving the slave robot 11 based on an operation on the master robot 20. Accordingly, the specimen collection member 12a can be easily rotationally moved while the horizontal inclination of the image 13a captured by the imager 13 is maintained constant.

According to this embodiment, as described above, the slave robot 11 includes the vertical articulated robot having the plurality of joints, and the controller 30 is configured or programmed to move the slave robot 11 while adjusting the posture of the imager 13 using the vertical articulated robot such that the horizontal side 13b of the image 13a captured by the imager 13 is substantially horizontal when moving the slave robot 11 based on an operation on the master robot 20. Accordingly, the horizontal inclination of the image 13a captured by the imager 13 can be easily maintained constant (substantially horizontal) by driving the plurality of joints of the vertical articulated robot.

According to this embodiment, as described above, the imager 13 is attached to the mount 11b such that the imager 13 is spaced apart downward from the hand 12 and the imaging direction of the imager 13 is inclined upward. Accordingly, the imager 13 can be offset with respect to the hand 12, and thus the state of the specimen collection member 12a held by the hand 12 can be imaged by the imager 13.

According to this embodiment, as described above, the robot system 100 includes the clutch operator 24 to temporarily release the slave robot 11 from following the master robot 20, and the position return operator 25 to return the positional relationship of the master robot 20 with respect to the slave robot 11 to the standard state. Furthermore, the controller 30 is configured or programmed to perform a control to move at least one of the master robot 20 or the slave robot 11 such that the position of the master robot 20 matches the position of the slave robot 11 based on the operation on the position return operator 25. Accordingly, even when the positional relationship between the master robot 20 and the slave robot 11 is temporarily changed from the standard state by operating the clutch operator 24, the positional relationship between the master robot 20 and the slave robot 11 can be returned to the standard state by operating the position return operator 25. Consequently, the influence on the operability of the slave robot 11 by the master robot 20, such as the slave robot 11 being located in the vicinity of the end of its movable range and becoming unable to move, can be reduced or prevented.

According to this embodiment, as described above, the controller 30 is configured or programmed to perform a control to move the master robot 20 such that the position of the master robot 20 matches the position of the slave robot 11 while stopping the slave robot 11 based on an operation on the position return operator 25. Accordingly, the slave robot 11 does not move by operating the position return operator 25, and thus when the positional relationship between the master robot 20 and the slave robot 11 is returned to the standard state, interference of the slave robot 11 with the surrounding objects can be reduced or prevented. Consequently, the positional relationship between the master robot 20 and the slave robot 11 can be returned to the standard state even during specimen collection, for example.

According to this embodiment, as described above, the robot system 100 includes the partition wall 10a provided between the slave robot 11 and the subject S and including the opening 10b through which the specimen collection member 12a passes. Furthermore, the controller 30 is configured or programmed to move the slave robot 11 such that the specimen collection member 12a passes through the columnar movable range 10c that is set across the front and back of the opening 10b and follows the shape of the opening 10b. Accordingly, contact of the specimen collection member 12a with the partition wall 10a can be reduced or prevented, and thus adhesion of the collected specimen to the partition wall 10a can be reduced or prevented.

According to this embodiment, as described above, the movable range 10c is set such that the portion of the movable range 10c on the subject S side is longer than the portion of the movable range 10c on the slave robot 11 side with respect to the partition wall 10a. Accordingly, in the portion on the subject S side that is far from the slave robot 11 with respect to the partition wall 10a, a portion in which movement of the specimen collection member 12a is restricted can be made longer, and thus contact of the specimen collection member 12a with objects other than other than the subject S can be reduced or prevented in an area on the subject S side.

According to this embodiment, as described above, the robot system 100 includes the shape acquirer 14 to acquire the three-dimensional shape of the vicinity of the site of the subject S from which a specimen is to be collected. Furthermore, the controller 30 is configured or programmed to adjust movement of the slave robot 11 based on the three-dimensional shape acquired by the shape acquirer 14 to move the slave robot 11. Accordingly, even when the position of the site from which the specimen is to be collected differs due to individual differences of the subject S, the position of the site from which the specimen is to be collected can be easily acquired by acquiring the three-dimensional shape by the shape acquirer 14, and thus specimens can be easily collected from various subjects S.

According to this embodiment, as described above, the controller 30 is configured or programmed to perform at least one of an adjustment of the initial position of the slave robot 11 for collecting a specimen from the subject S or an adjustment of the movement range of the slave robot 11 for collecting a specimen from the subject S based on the three-dimensional shape acquired by the shape acquirer 14. Accordingly, the specimen collection member 12a can be smoothly moved toward the subject S from the adjusted initial position by adjusting the initial position of the slave robot 11 for collecting a specimen from the subject S based on the acquired three-dimensional shape, and thus a specimen can be more easily collected from the subject S. Furthermore, the slave robot 11 can be moved within the movement range adjusted according to the subject S by adjusting the movement range of the slave robot 11 for collecting a specimen from the subject S based on the acquired three-dimensional shape, and thus a specimen can be more easily collected from the subject S.

### Modified Examples

The embodiment disclosed this time must be considered as illustrative in all points and not restrictive. The scope of the present disclosure is not shown by the above description of the embodiment but by the scope of claims for patent, and all modifications (modified examples) within the meaning and scope equivalent to the scope of claims for patent are further included.

For example, while the example in which the robot system is used to collect a specimen from the person to be treated by remote control has been shown in the aforementioned embodiment, the present disclosure is not limited to this. In the present disclosure, the operation person may perform a procedure other than specimen collection on the person to be treated by remote control using the robot system. The robot system may be used to perform an examination on the person to be treated, for example.

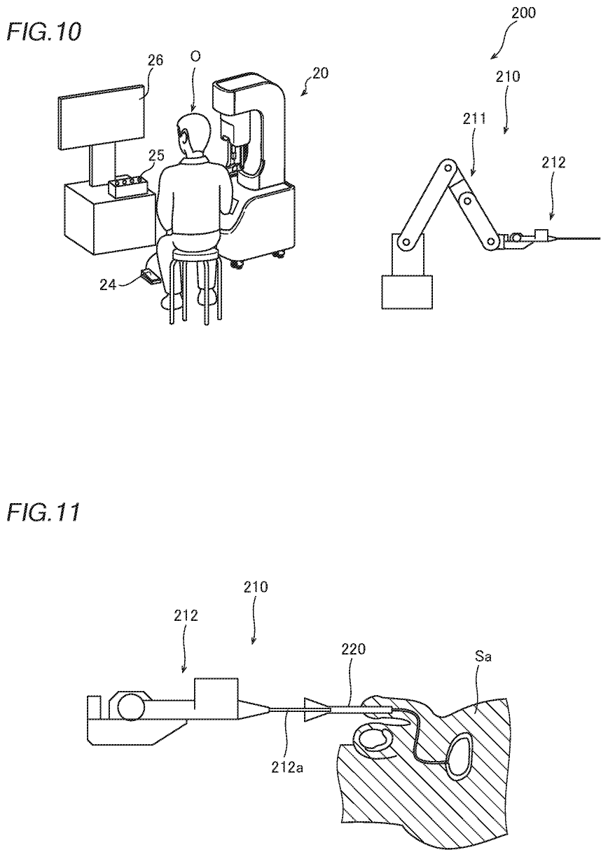

Specifically, as shown in FIGS. 10 and 11, an endoscope such as a ureteroscope may be inserted into the person to be treated Sa, and a procedure such as examination and treatment may be performed. In an example of a robot system 200 shown in FIG. 10, an operation person O operates a slave robot 210 using a master robot 20. The slave robot 210 includes a robot arm 211 and a treatment member 212, such as a ureteroscope, provided at a tip end of the robot arm 211. As shown in FIG. 11, a tip end 212a of the treatment member 212 including an imager and a treatment portion is inserted into the ureter through a ureteral access sheath 220 inserted into the urethral opening. Furthermore, the position and posture of the treatment member 212 are changed by the robot arm 211. Thus, the operation person O can perform the procedure on the person to be treated Sa by remote control. An image captured by the imager provided at the tip end 212a is displayed on a display 26 arranged on the master robot 20 side.

While the example in which the slave robot is a vertical articulated robot has been shown in the aforementioned embodiment, the present disclosure is not limited to this. In the present disclosure, the slave robot may be a robot other than a vertical articulated robot such as a horizontal articulated robot and/or a dual-arm robot.

While the example in which the clutch operator includes the pedal operator has been shown in the aforementioned embodiment, the present disclosure is not limited to this. In the present disclosure, the clutch operator may be a button operated by hand or a virtual button displayed on a touch panel.

While the example in which the position return operator includes the button operated by hand has been shown in the aforementioned embodiment, the present disclosure is not limited to this. In the present disclosure, the position return operator may be a virtual button displayed on a touch panel.

While the example in which one slave robot is provided has been shown in the aforementioned embodiment, the present disclosure is not limited to this. In the present disclosure, a plurality of slave robots may be provided for one master robot.

While the example in which the imager provided at the tip end of the slave robot is provided below the hand has been shown in the aforementioned embodiment, the present disclosure is not limited to this. In the present disclosure, the imager provided at the tip end of the slave robot may be provided above or lateral to the hand.

While the process operations of the controllers are described using a flow in a flow-driven manner in which processes are performed in order along a process flow for the convenience of illustration in the aforementioned embodiment, the present disclosure is not limited to this. In the present disclosure, the process operations of the controllers may be performed in an event-driven manner in which the processes are performed on an event basis. In this case, the process operations may be performed in a complete event-driven manner or in a combination of an event-driven manner and a flow-driven manner.

### DESCRIPTION OF REFERENCE NUMERALS

10c: movable range
11: slave robot
11b: mount
12: hand
12a: specimen collection member (treatment member)
14: shape acquirer
20: master robot
24: clutch operator
25: position return operator
30: controller
100: robot system
S: subject (person to be treated)

1. A robot system comprising:
a master robot;
a slave robot remotely controlled by the master robot to perform a procedure on a person to be treated;
a mount connected to a tip end of the slave robot;
a hand attached to the mount to hold a treatment member operable to perform the procedure on the person to be treated;
a controller configured or programmed to control movement of the slave robot based on an operation on the master robot;
a clutch operator to temporarily release the slave robot from following the master robot; and
a position return operator to return a positional relationship of the master robot with respect to the slave robot to a standard state; wherein
the controller is configured or programmed to perform a control to move at least one of the master robot or the slave robot such that a position of the master robot matches a position of the slave robot based on an operation on the position return operator.

2. The robot system according to claim 1, wherein the controller is configured or programmed to perform a control to move the master robot such that the position of the master robot matches the position of the slave robot while stopping the slave robot based on the operation on the position return operator.

3. The robot system according to claim 1, further comprising:
a shape acquirer to acquire a three-dimensional shape of a vicinity of a site of the person to be treated on which the procedure is to be performed; wherein
the controller is configured or programmed to adjust the movement of the slave robot based on the three-dimensional shape acquired by the shape acquirer to move the slave robot.

4. The robot system according to claim 3, wherein the controller is configured or programmed to perform at least one of an adjustment of an initial position of the slave robot for performing the procedure on the person to be treated or an adjustment of a movement range of the slave robot for performing the procedure on the person to be treated based on the three-dimensional shape acquired by the shape acquirer.
